(19) United States
(12) Patent Application Publication
(10) Pub. No.: US 2026/0169270 A1
(43) Pub. Date: Jun. 18, 2026

(54) OVERMOLDED LENSES

(71) Applicant: HEPTAGON PHOTONICS PTE. LTD., Singapore (SG)

(72) Inventors: Hongyuan LIU, Singapore (SG); John VIDALLON, Singapore (SG); Lope Vallespin PEPITO, JR., Singapore (SG); Anh Chien NGUYEN, Singapore (SG); Han Nee NG, Singapore (SG)

(21) Appl. No.: 19/529,590

(22) Filed: Feb. 4, 2026

Related U.S. Application Data
(63) Continuation of application No. PCT/SG2024/050459, filed on Jul. 17, 2024.

(30) Foreign Application Priority Data
Aug. 30, 2023 (DE) 10 2023 123 342.4

(51) Int. Cl. G02B 13/00

(52) U.S. Cl. CPC G02B 13/0085

(57) ABSTRACT

The present disclosure relates to an optical component including: a first lens element configured as a lens of a first lens type; and a second lens element configured as a lens of a second lens type, wherein the second lens element is formed on a first lens surface of the first lens element, such that the second lens element is fixedly coupled with the first lens element via a direct interface between the first lens surface of the first lens element and a second lens surface of the second lens element.

### TECHNICAL FIELD

The present disclosure relates generally to an optical component including a plurality of lens elements formed directly on one another, and to methods thereof (e.g., a method of fabricating an optical component).

### BACKGROUND

In general, optical components to manipulate light are a key part in various types of devices such as sensors, cameras, display devices, medical equipment, and the like. In particular, optical lenses allow shaping a light beam according to a desired application, e.g. to focus the light beam towards a particular direction, to collimate a light beam for uniform light emission, etc. In view of the constant trend towards miniaturization, wafer-level optics is a technique for fabricating miniaturized optical components, such as wafer-level lenses, arrays of microlenses, and the like. Wafer-level optics may illustratively describe the use of techniques typical of the semiconductor industry for manufacturing optical components. Wafer-level optics is commonly exploited for camera modules, e.g. for integration in portable devices such as tablets, smartphones, and the like. Improvements in optical components, and in particular in optical components fabricated via wafer-level manufacturing, may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows an imaging device in a schematic view, according to various aspects;

FIG. 2A shows an optical component including a plurality of lens elements in a schematic representation, according to various aspects;

FIG. 2B shows the optical component including a third lens element in a schematic representation, according to various aspects;

FIG. 2C and FIG. 2D show the optical component further including an optical substrate in a schematic representation, according to various aspects;

FIG. 3A shows possible configurations of a lens element of the optical component in a schematic representation, according to various aspects;

FIG. 3B shows possible configurations of the optical component in a schematic representation, according to various aspects;

FIG. 3C and FIG. 3D show microscope images of exemplary optical components according to various aspects;

FIG. 4 shows a schematic flow diagram of a method of fabricating an optical component, according to various aspects; and

FIG. 5 shows an illustrative representation of a method of fabricating an optical component, according to various aspects.

### DETAILED DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., an optical component, an imaging device). However, it is understood that aspects described in connection with methods may similarly apply to the devices, and vice versa.

In general, imaging devices capable of capturing three-dimensional (3D) information within a scene are of great importance for a variety of application scenarios. A prominent example is the use of tracking sensors for augmented reality (AR) and virtual reality (VR) applications. For example, a world-tracking sensor allows sensing the environment around the user wearing the sensor, a gesture-tracking sensor allows sensing where the user's fingers and hands are, an eye-tracking sensor allows sensing where exactly the user is looking at, etc. Sensing data from the tracking sensors enable a variety of functionalities in the AR- and VR-context, such as presenting information to the user, executing commands based on a gesture or a gaze of the user, and the like. Other fields of application may include face recognition and authentication in modern smartphones, factory automation for Industry 5.0, authentication systems for electronic payments, internet of things (IoT) environments, and the like.

Tracking sensors for augmented reality and/or virtual reality may be camera-based visual sensors operating in the visible spectral bandwidth and/or near infrared (NIR) spectral bandwidth, in view of the human sense of sight. An imaging device for such applications may usually include a compact camera module (CCM) for sensing light and generating corresponding sensing data. A camera-based tracking sensor may usually include a CMOS image sensor (CIS), where CMOS stands for Complementary Metal-Oxide Semiconductor. A camera-based tracking sensor may further include an optical lens module to collect light from the field of view of the sensor and direct the collected light to the image sensor (e.g., the CMOS image sensor). With the advancements of new generations of imaging devices, there is a constant demand for a miniaturization of their mechanical, optical, and electrical components.

In the context of small-footprint optical systems, wafer-level optics is a technique for fabricating miniaturized optical components, such as wafer-level lenses. The general aspects related to wafer-level optics and corresponding fabrication techniques are well known in the art. A brief description is provided herein to introduce aspects relevant for the present disclosure.

Wafer-level optics may be based on processes typical of semiconductor manufacturing, such as thin film deposition, lithography, etching, molding, imprinting, and the like. For example, in wafer-level optics, optical components may be fabricated using molds, thus enabling mass production. As an abridged overview, wafer-level optics may include imprinting to fabricate optical components at the wafer-level, and then a layer-by-layer stacking of the individual optical components to assemble the final product. The resulting optical module may finally be coupled, e.g. bonded, with an image sensor (e.g., a CMOS image sensor) at the wafer-level. Wafer-level optics may thus allow producing optical modules with a reduced footprint compared to other fabrication techniques.

Wafer-level optics may thus refer to the mass production of micro-optical components on a wafer level. Wafer-level optics offers the capabilities to produce small and precise optical components, including lenses. In general, WLO lenses may be particularly useful for applications where space is at a premium, such as in smartphones, wearables, and other portable electronic devices. The market demand for WLO lenses has been increasing due to several factors. First, the trend towards miniaturization of electronic devices has led to a need for smaller optical components. WLO lenses can be manufactured with a very small form factor, making them ideal for these types of applications. Second, the scalability of WLO lens fabrication allows for high volume production, which can help reduce the cost per unit and increase the overall efficiency. Finally, the performance of WLO lenses has improved significantly in recent years, making them a viable alternative to traditional optical components, e.g. glass lenses and injection molded plastic lenses. Overall, WLO lenses may thus offer various benefits over traditional lenses, including small form factor, scalability, and reflowability (if a reflowable epoxy material is used). These factors have contributed to the increasing market demand for WLO lenses, particularly in the consumer electronics industry.

A conventional approach for producing WLO lenses involves molding a single epoxy material onto a substrate, typically a glass wafer but not limited to glass material. However, this approach has limitations, including the presence of spherical and chromatic aberrations that can negatively impact the performance of the optical system. One solution to correct or compensate for these aberrations is to increase the number of lens elements and stack them together with a designed air-gap distance. However, this approach may be expensive and prone to alignment errors due to tolerance stack-up.

The present disclosure may be based on the realization that rather than providing a conventional stack of lenses, the lens elements (illustratively, the individual lenses of the lens stack) may be formed directly one on the other to implement a desired optical function and reduce spherical and chromatic aberrations. Illustratively, the present disclosure may be based on the realization that a lens element may be formed (e.g., overmolded) directly on the lens surface of another lens element, thus creating a lens stack without the risk of alignment errors and providing an overall simpler fabrication procedure.

The present disclosure may be based on the realization that rather than forming and subsequently stacking individual lens elements (e.g., on different substrates), an optical component may be advantageously fabricated by directly coupling the lens surfaces of the lens elements by forming the lens elements on one another and without further intervening components (e.g., bonding layers, air gaps, and the like). This configuration may enable a scalable fabrication of optical lens modules without the need for cumbersome alignment steps during the stacking of individual lens elements. Furthermore, the lens shapes and optical properties of the lenses (e.g., refractive index and Abbe number) may be engineered to reduce aberrations in the optical system, improving the overall optical performance.

Conventional approaches for coupling lenses, e.g. traditional lenses such as glass lenses, may make use of bonding layers to connect two lens elements. However, such an approach may be extremely challenging for bonding small lens elements such as microlenses. The approach proposed herein that includes a direct interface between the lens elements eliminates the need for a bonding layer and is viable for manufacturing extremely small and precise lenses. Furthermore, with the proposed strategy it may be possible to form (e.g., mold) multiple lenses in sequence, thus providing a time- and resource-efficient fabrication.

According to various aspects, an optical component includes: a first lens element configured as a lens of a first lens type; and a second lens element configured as a lens of a second lens type, wherein the second lens element is formed on a first lens surface of the first lens element, such that the second lens element is fixedly coupled with the first lens element via a direct interface between the first lens surface of the first lens element and a second lens surface of the second lens element.

In a corresponding manner, a method of fabricating an optical component may be provided, the method including: providing a first lens element configured as a lens of a first lens type; and forming a second lens element directly on a first lens surface of the first lens element, such that the second lens element is fixedly coupled with the first lens element via a direct interface between the first lens surface of the first lens element and a second lens surface of the second lens element, wherein the second lens element is configured as a lens of a second lens type.

In the present disclosure the term “lens element” is used to describe a lens that is part of an optical component and that is configured to implement a predefined lens function. A lens element may thus be configured to manipulate light passing through the lens element according to the corresponding lens function for which the lens element is designed. A lens element may illustratively be an optical surface configured (e.g., shaped) to define a predefined manipulation of the light. For example the predefined lens function may include focusing light, diffracting light, collimating light, diverging light, projecting a light pattern, etc. A “lens element” may also be referred to herein simply as “lens”. A “lens function” may be understood as an optical manipulation of light according to the lens type of the respective lens element (e.g., concave lens, convex lens, etc.). The term “optical component” may describe a component including a plurality of lens elements that in combination define a desired manipulation of the light.

The present disclosure may thus be related to a novel approach for lens production. Although not limited thereto, the proposed approach may be of particular relevance in the context of wafer-level optics, and may overcome the limitations mentioned above and may improve the overall optical performance. In a preferred configuration, the fabrication of the optical component may thus include wafer-level optics techniques, e.g. the optical component and lens element(s) may be fabricated via wafer-level optics manufacturing. As mentioned above, wafer-level optics techniques allow fabricating optical elements with a reduced footprint, which is of particular relevance in nowadays devices (e.g., sensors for AR/VR, smartphones, tablets, etc.). It is however understood that, in principle, the aspects described herein may also apply in a corresponding manner to an optical component or lens element(s) fabricated via other types of techniques known in the art. Some further possible fabrication techniques will be described in further detail below.

In a preferred configuration, a lens element may include or may be made of an epoxy material. An epoxy-lens or epoxy-based lens may be the most relevant use case for the strategy described herein, since epoxy materials are commonly used in wafer-level fabrication and, in general, for providing small-footprint lenses or other types of miniaturized optical elements. It is however understood that, in principle, a lens element of the described optical component may also include or consist of different types of materials (e.g., glass, a polymer, and the like).

The term “epoxy” may be used herein as commonly understood in the art to describe a thermosetting polymer that includes epoxide groups. The term “epoxy” may be used herein to refer both to the “uncured” state (or non-hardened state) and the “cured” state (or hardened state, or cross-linked state) of the material. In some aspects, the term “epoxy resin” may be used to refer to the material in its “uncured” state. The epoxy may go from the “uncured” state to the “cured” state by means of a treatment that causes a cross-linking of the polymer chains. Illustratively, an epoxy resin may harden via chemical reactions that may be induced in any suitable manner (e.g., via a heat treatment or via irradiation with ultraviolet light), or by combining the epoxy resin with other components (illustratively, with a “hardener”). The term “epoxy lens” may be used herein to describe a lens element that substantially consists of epoxy material, e.g. a lens element made of epoxy material by more than 50% by volume, or by more than 70% by volume, or by more than 90% by volume, or by more than 99% by volume. An “epoxy lens” may include a single epoxy material or a combination (a mixture) of epoxy materials.

According to various aspects the present disclosure may be related to overmolding of an epoxy lens on another epoxy lens using wafer-level processing. This novel process may be repeated to overmold multiple lenses onto the existing structure. The multiple layered lens structure may thus include two or more different epoxy lenses molded together without the need for a bonding layer. The proposed configuration simplifies thus the fabrication process, since no bonding layer is required and further there is a reduced risk of misalignment of the lenses.

In some aspects, the present disclosure also specifies a manufacturing process for producing the optical component using a wafer-level optics (WLO) replication process. The first step may include molding a lens using a first epoxy material onto a substrate, e.g. a glass wafer. Then, a second epoxy material may be molded onto the first lens, using the first lens as the substrate. This creates a lens structure with two distinct layers of epoxy material, e.g. each with a different refractive index and Abbe number, which can further reduce aberrations in the optical system.

The process of using the first lens as a substrate for the second layer of epoxy material also ensures precise alignment between the two layers, eliminating the need for a bonding layer and reducing the risk of alignment errors. This process can be repeated to overmold multiple lenses onto the existing structure, providing more design freedom and flexibility, and reducing the need for complicated design with more air-spaced single lens elements.

In the context of the present disclosure particular reference may be made to applications of an optical component configured as described herein for light detection purposes. Illustratively, particular reference may be made to a use of the lens stack for receiving light and focusing light onto an image sensor (e.g., a CMOS sensor). This application may be a relevant use case for the proposed optical component, e.g. in the context of AR- or VR-applications. It is however understood that in principle an optical component configured as described herein may also be used at the emitter-side of an optical system, e.g. to manipulate the emitted light.

An imaging device including the optical component may be integrated in a host device that exploits the imaging device to implement one or more functionalities (e.g., telecommunications, distance measurements, object tracking, and the like). Exemplary host devices for the imaging device may include a mobile communication device (e.g., a smartphone, a tablet, a laptop), a vehicle (e.g., a car), an automated machine (e.g., a drone, a robot), and the like.

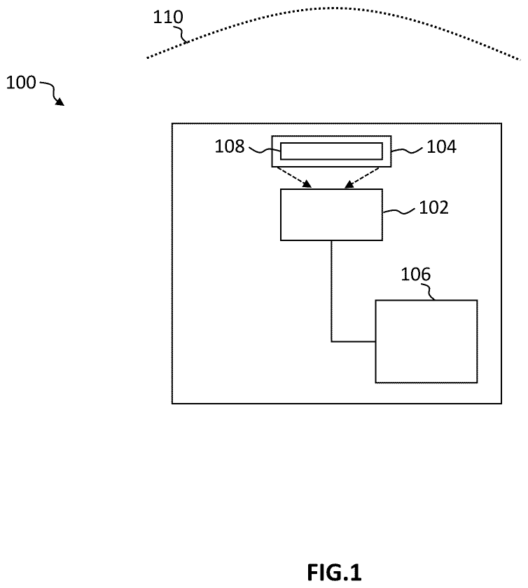

FIG. 1 shows an imaging device 100 in a schematic representation, according to various aspects. The imaging device 100 may be an exemplary device that includes one or more image sensors, e.g. for light detection, imaging, face recognition, and the like. It is understood, that the imaging device 100 provides an exemplary and simplified configuration of a possible application scenario of an optical component as described herein. In an exemplary configuration, the imaging device 100 may be a tracking sensor, e.g. the imaging device 100 may be configured to track one or more features (one or more elements) in a field of view 110 of the imaging device 100, as discussed in further detail below. As other examples, the imaging device 100 may be configured as a time-of-flight sensor, a proximity sensor, a stereo vision sensor, and the like. The representation of the imaging device 100 may be simplified for the purpose of illustration, and the imaging device 100 may include additional components with respect to those shown, such as one or more filters, one or more amplifiers, etc.

The imaging device 100 may include an image sensor 102. The image sensor 102 may be configured to be sensitive for light in a predefined wavelength range, e.g. the visible range (e.g., from about 380 nm to about 800 nm), infrared and/or near-infrared range (e.g., in the range from about 800 nm to about 5000 nm, for example in the range from about 820 nm to about 1200 nm, for example at or around 940 nm), and/or ultraviolet range (e.g., from about 100 nm to about 400 nm). Illustratively, the image sensor 102 may be configured to convert light energy (illustratively, photons) of light impinging onto the image sensor 102 in electrical energy (e.g., in a current, illustratively a photo current). In general, the imaging device 100 may have compact dimensions, e.g. a small footprint size. For example, the image sensor 102 may be a chip-scale packaged image sensor.

The geometry (e.g., the shape and lateral dimensions) of the image sensor 102 may be adapted according to the system requirements, e.g. according to an overall dimension of the imaging device 100, according to fabrication constraints, etc. The image sensor 102 may thus have any suitable shape, such as a rectangular shape, a square shape, or even asymmetric shapes. In general, the image sensor 102 may include a plurality of pixels, e.g. a first plurality of pixels Nₓ defining a first dimension, and a second plurality of pixels N_{y} defining a second dimension. In various aspects, the image sensor may include a two-dimensional array of pixels. A number of pixels Nₓ, N_{y} in each direction, as well as a pixel pitch, may be adapted depending on the desired dimension of the image sensor 102. As a numerical example, the image sensor 102 may include at least 10⁴ pixels (e.g., 100×100 pixels), for example at least 4×10⁴ pixels (e.g., 200×200 pixels). As another numerical example, the image sensor 102 may have a lateral dimension (e.g., a width) in the range from 1 mm to 10 mm, for example in the range from 2 mm to 5 mm.

According to various aspects, the image sensor 102 may be configured according to CMOS-technology, e.g. the image sensor 102 may be a CMOS image sensor. In this configuration, the image sensor 102 may include a plurality of CMOS pixels, each including a photodetector that accumulates an electrical charge based on the amount of light impinging onto the photodetector. As another exemplary configuration, the image sensor 102 may be configured according to Charged Coupled Device (CCD) technology, e.g. the image sensor 102 may be a CCD image sensor. In this configuration, the image sensor 102 may include a plurality of CCD pixels with a photoactive region and a transmission region.

In the imaging device 100, an optical module 104 may define the field of view 110 of the image sensor 102. Illustratively, the optical module 104 may be configured to collect light and direct (e.g., focus) the collected light onto the image sensor 102, e.g. on one or more of the pixels of the image sensor 102. According to various aspects, the optical module 104 may include one or more optical components 108 to focus the received light onto the image sensor 102. The image sensor 102 may be disposed in the image plane of the one or more optical components 108.

The imaging device 100 may further include a processor 106 configured to receive image data from the image sensor 102 and carry out processing of the image data. For example, the processor 106 may be coupled with an analog-to-digital converter configured to convert an analog signal from the image sensor 102 (e.g., a photo current) into a digital signal to enable digital processing at the processor 106. The processor 106 may be configured to analyze and manipulate the image data according to the function provided by the imaging device 100.

As an example, the processor 106 may be configured to carry out a tracking of an element in the field of view 110. Illustratively, the processor 106 may be configured to follow an evolution of a spatial position of the element over time, e.g. to associate two-dimensional coordinates or three-dimensional coordinates corresponding to a position of the element to a respective time point. The tracked element may be any suitable feature or object of interest, such as the hand of a user, the eyes of a user, a vehicle, an animal, etc.

As another example, the processor 106 may be configured to calculate a time-of-flight associated with the received light. The processor 106 may receive a signal indicative of an emission time of the light and may identify a time of arrival of light at the imaging device 100 based on the signal delivered by the image sensor 102. This configuration may be provided, for example, for mapping the presence of objects in the field of view 110, and their properties such as distance from the device 100, speed, direction of motion, and the like.

As a further example, the processor 106 may be configured to determine (e.g., estimate, measure) the distortion of a predefined light pattern (e.g., a grid of light dots for example). This configuration may be provided, for example, for face-recognition applications, in which the distortion of the emitted pattern is associated to the profile of an object (e.g., a person) in the field of view 110. For example, the processor 106 may be configured to reconstruct a shape of the object (e.g., a face) based on the distorted pattern.

In an exemplary configuration, the imaging device 100 may further include a light emission system (not shown) configured to emit light into the field of view 110. Illustratively, the light emission system may emit light in a field of illumination that overlaps (fully, or at least in part) with the field of view 110. The light emission system may include emitter optics (e.g., one or more lenses, one or more mirrors, and the like) and a light source configured to emit light in a predefined wavelength range. As an example, the light source may be or include a laser source, e.g. a Vertical Cavity Surface Emitting Laser (VCSEL) or a VCSEL-array. The light source may be configured to emit light having a predefined wavelength, illustratively in the same wavelength range or ranges for which the image sensor 102 is sensitive.

The light source may be configured to emit light in any suitable manner depending on the overall configuration of the imaging device 100. As an example, the light source may emit continuous light. As another example, the light source may emit light in a pulsed manner (e.g., for time-of-flight measurements), e.g. the light source may emit a sequence of light pulses. As a further example, the light emission system may emit light according to a predefined pattern, e.g. a grid of light dots. In an exemplary configuration, the processor 106 may be configured to control the light emission by the light source, e.g. the processor 106 may be configured to instruct or cause the light emission, e.g. at a certain time point, at certain time intervals, in response to a certain event, and the like.

As mentioned above, the optical module 104 may include an optical component 108, or a plurality of optical components 108 (e.g., arranged in a stack), for manipulating light, e.g., for focusing light onto the image sensor 102. The present disclosure may be based on the realization that the fabrication of conventional optical components for small footprint systems may be prone to alignment errors in view of the stacking of multiple lenses to correct for spherical and chromatic aberrations. The present disclosure may thus be based on the realization how an optical component (e.g., for a small footprint device, e.g. a small footprint sensor) may be fabricated to deliver a robust lens stack with a procedure that does not suffer from the alignment issues of conventional approaches.

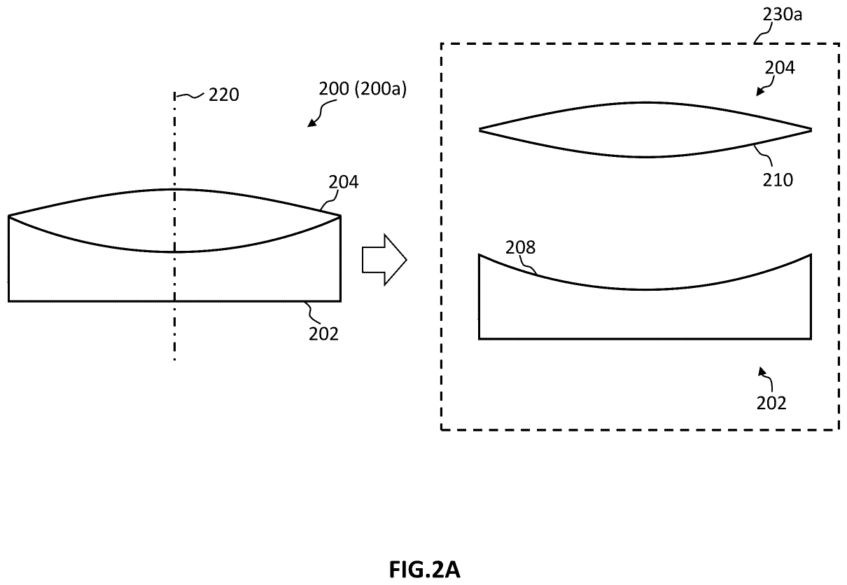

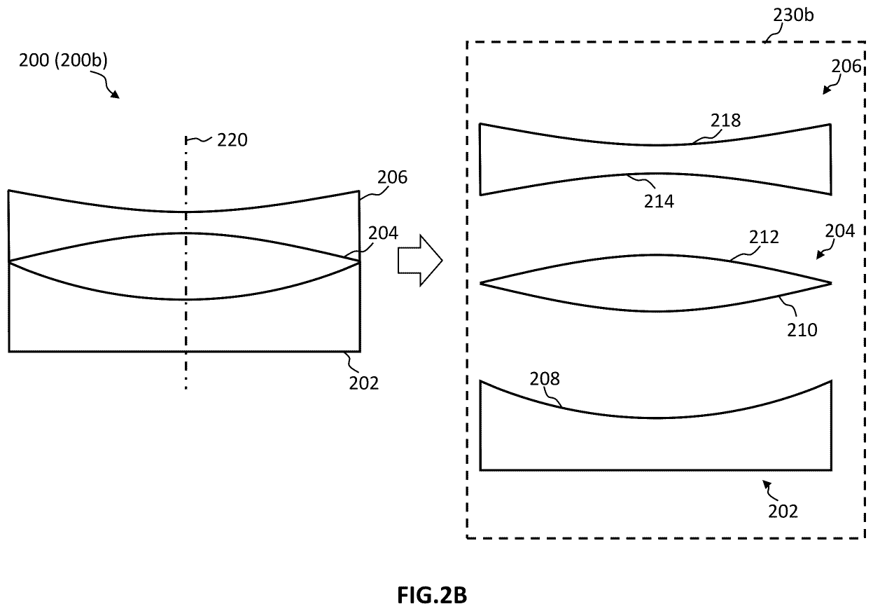

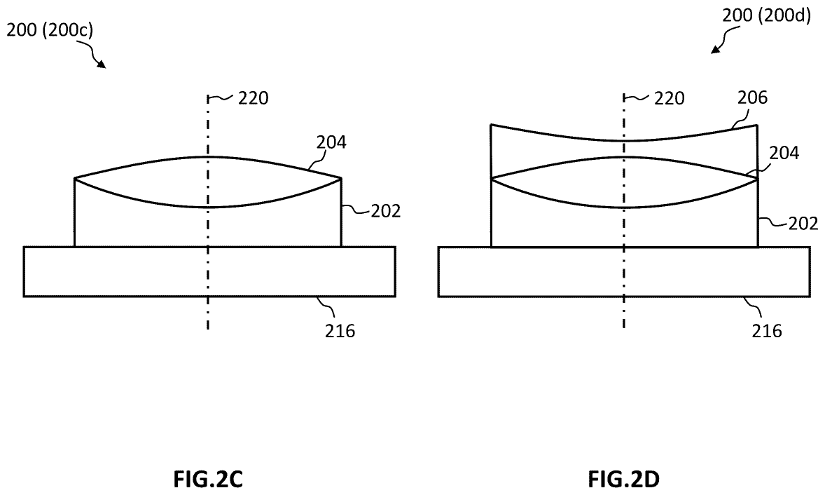

FIG. 2A to FIG. 2D show an optical component 200 in a schematic representation, according to various aspects. FIG. 2A to FIG. 2D show possible configurations 200a, 200b, 200c, 200d of the optical component, which are collectively referred to as optical component 200. The optical component 200 may be an adapted configuration of an optical component (e.g., the optical component 108) for use in an imaging device (e.g., the imaging device 100). The optical component 200 may also be referred to herein as optical element 200 or optical module 200.

In general, the optical component 200 may include a plurality of lens elements 202, 204, 206 stacked on one another. According to the configuration proposed herein, the lens elements 202, 204, 206 may be formed directly on one another, without further intervening bonding elements between the lenses. As discussed above, this configuration may allow obtaining a lens stack in a simpler manner, in which a desired optical function may be obtained by shaping the lens elements accordingly, and in which aberrations may be reduced or eliminated by selecting suitable materials (with suitable refractive indexes) for the lens elements.

In FIG. 2A (and FIG. 2C) a configuration of the optical component 200 with two lens elements 202, 204 is illustrated, and in FIG. 2B (and FIG. 2D), a configuration of the optical component 200 with three lens elements 202, 204, 206 is illustrated. It is however understood that an optical component as proposed herein may include any suitable number of stacked lens elements, e.g., two, three, four, five, or more than five. It is also understood that the general properties discussed in relation to the lens elements 202, 204, 206 illustrated in FIG. 2A to FIG. 2D (e.g., in terms of type of materials, dimensions, profile, etc.) may apply in a corresponding manner to further lens elements of the optical component (e.g., a fourth lens element, a fifth lens element, etc.). A “lens element” may also be referred to herein simply as “lens”.

For purpose of illustration, FIG. 2A and FIG. 2B show a respective configuration 200a, 200b of the optical component 200 and further a view 230a, 230b in which the individual lens elements 202, 204, 206 are shown separated from one another.

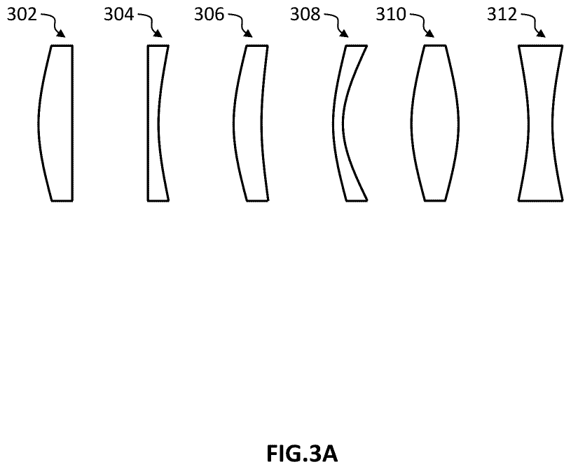

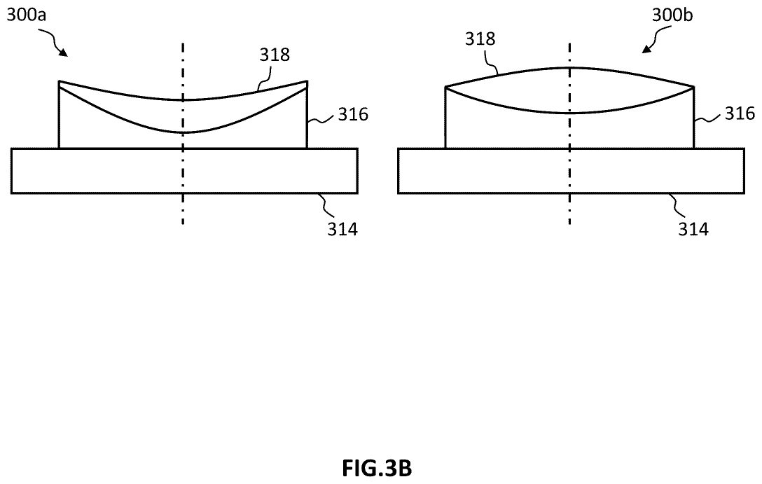

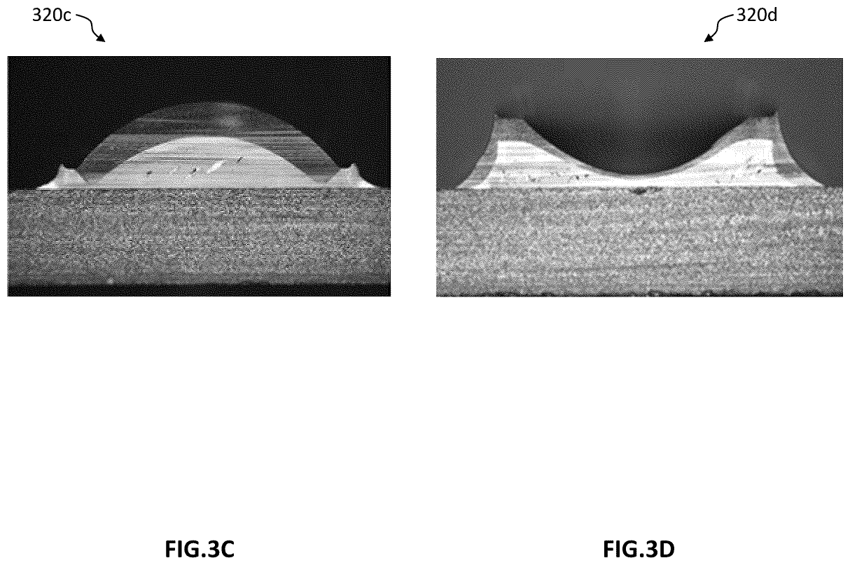

According to various aspects, the optical component 200 may include a plurality of lens elements (e.g., a first lens element 202, a second lens element 204, a third lens element 206, etc.), and a lens element may be formed directly on the surface of another lens element to create a direct coupling (a direct physical interface) between the lens elements. The lens elements 202, 204, 206 may be of any suitable lens type (see also FIG. 3A). It is thus understood that the types of lens elements shown in FIG. 2A to FIG. 2D are exemplary, and also other lens types may be provided, as discussed in further detail in relation to FIG. 3A to FIG. 3D.

Illustratively, each lens element 202, 204, 206 may be configured according to a respective lens type and may be configured to perform a respective lens function, e.g. a respective optical manipulation of light passing through the lens element 202, 204, 206. The first lens element 202 may be configured as a lens of a first lens type and may be configured to perform/implement a first lens function, the second lens element 204 may be configured as a lens of a second lens type and may be configured to perform/implement a second lens function, the third lens element 206 may be configured as a lens of a third lens type and may be configured to perform/implement a third lens function, etc.

In the configuration in FIG. 2A, the second lens element 204 may be formed on a first lens surface 208 of the first lens element 202. The “forming” (e.g., the overmolding) of the second lens element 204 directly on the first lens element 202 may provide that the second lens element 204 is fixedly coupled with the first lens element 202 via a direct interface between the first lens surface 208 and a second lens surface 210 of the second lens element 204. In a corresponding manner, the third lens element 206 may be formed on a further (second) lens surface 212 of the second lens element 204, such that that the third lens element 206 may be fixedly coupled with the second lens element 204 via a direct interface between the further lens surface 212 and a third lens surface 214 of the third lens element. In case of further lens elements, a fourth lens element may be fixedly coupled with the third lens element 206 at a further lens surface of the third lens element 206, etc.

Illustratively, the lens elements 202, 204, 206 may be directly coupled without further intervening elements therebetween. The first lens surface 208 of the first lens element 202 may thus be in direct physical contact with the second lens surface 210 of the second lens element 204. Correspondingly, the further lens surface 212 of the second lens element 204 may be in direct physical contact with the third lens surface 214 of the third lens element 206, etc. An “interface” between lens elements may accordingly be a direct physical interface that connects (and fixes) the respective lens surfaces, e.g. the first lens surface 208 with the second lens surface 210, the further (second) lens surface 212 with the third lens surface 214, etc.

In this regard, the term “lens surface” may be used to describe a main surface of a lens element (e.g., a top surface or a bottom surface considering a “vertical stack”). A “lens surface” may be a surface of the portion of the lens element dedicated to the optical function/lens function implemented by the lens element. A “lens surface” may be a surface through which light rays propagate during an operation of the lens element, e.g. a surface into which light rays are input or a surface from which light rays are output during an operation of the lens element. For example, a “lens surface” may be a surface of a lens element through which the optical axis of the lens element passes. For example, a “lens surface” may cause refraction of light that passes through the lens surface.

For example, a “lens surface” may be a curved surface of a lens element (e.g., a convex surface, a concave surface, a positive meniscus, a negative meniscus).In an exemplary configuration, as shown in FIG. 2A and FIG. 2B, the first lens surface 208 may be a first curved surface, the second lens surface 210 may be a second curved surface, the further lens surface 212 may be a further curved surface, the third lens surface 214 may be a third curved surface, etc.

In general, a lens element may include at least two lens surfaces, e.g. an input lens surface and an output lens surface. In operation, the lens element may receive light at the input lens surface and may output light from the output lens surface. According to the proposed configuration, the input lens surface of a lens element (e.g., the second lens surface 210 of the second lens element 204, the third lens surface 214 of the third lens element 206, etc.) may form a direct interface and may touch the output lens surface of another lens element (e.g., the first lens surface 208 of the first lens element 204, the further lens surface 212 of the second lens element 204, etc.). The lens surface 208, 212 of a lens element 202, 204 may illustratively be used as substrate for forming another lens element 204, 206. By way of illustration, considering a sequence of materials, the optical component 200 may include, in sequence, a first material of the first lens element 202 and a second material of the second lens element 204 without further materials therebetween (and further a third material of the of the third lens element 206, etc.).

As mentioned, the lens elements 202, 204, 206 are fixedly coupled with one another via the direct interface between the lens surfaces 208, 210, 212, 214. Forming a lens element 204, 206 on another lens element 202, 204 (e.g., via molding and curing, as discussed below) may permanently bond the lens elements 202, 204, 206 to one another. The lens elements 202, 204, 206 are thus not removably coupled, but are rather fixedly attached at the lens surfaces 208, 210, 212, 214. The proposed configuration ensures thus mechanical stability for the optical component 200, without the risk of misalignments e.g. due to mechanical shocks.

The lens elements of optical component 200 may illustratively be stacked surface-to-surface. According to the proposed approach, the optical component 200 may be free of further (bonding) layers between the coupled lens elements. For example the optical component 200 may be free of a bonding layer between the lens surfaces of the coupled lens elements (e.g., between the first lens surface 208 and the second lens surface 210, between the further second lens surface 212 and the third lens surface 214, etc.). The optical component 200 may thus be free of any type of adhesive layer to bond the lens elements 202, 204, 206 to one another. The proposed approach may thus allow a fabrication in which the forming (e.g., alignment, deposition, etc.) of the bonding layers may be dispensed with.

According to various aspects, the optical component 200 may be free of an air-gap between the lens elements 202, 204, 206. As mentioned, the lens elements 202, 204, 206 may be directly stacked on one another, rather than relying on spacing elements or support elements as in other configurations. The direct stacking may provide a robust arrangement without alignment-related issues, as discussed above. With reference to the exemplary configurations in FIG. 2A and FIG. 2B, the optical component 200 may be free of an air-gap between the first lens surface 208 and the second lens surface 210, the optical component 200 may be free of an air-gap between the further second lens surface 212 and the third lens surface 214, etc.

In some aspects, the direct interface between lens elements 202, 204, 206 may correspond to the entire surface of one or both of the corresponding lens elements 202, 204, 206. In general, the lens surface 208, 210, 212, 214 of a lens element 202, 204, 206 may have a corresponding lateral extension, e.g. a corresponding diameter, and a corresponding surface area. For example, considering FIG. 2A and FIG. 2B, the first lens surface 208 may have a first lateral extension and a first surface area, the second lens surface 210 may have a second lateral extension and a second surface area, the third lens surface 214 may have a third lateral extension and a third surface area, etc. In an exemplary configuration, the direct interface between the lens elements 202, 204, 206 may have the same lateral extension (and surface area) as the corresponding lens surfaces 208, 210, 212, 214.

For example, in the case that the first lens surface 208 and the second lens surface 210 have the same lateral extension, the direct coupling between the first lens element 202 and the second lens element 204 may be over the entire first lens surface 208 and second lens surface 210. In a corresponding manner, in the case that the further second lens surface 212 and the third lens surface 214 have the same lateral extension, the direct coupling between the second lens element 204 and the third lens element 206 may be over the entire further second lens surface 212 and third lens surface 214, etc.

In another example, the lens elements 202, 204, 206 may have different dimensions, e.g. different diameters. For example, the second lens surface 210 may be smaller or larger than the first lens surface 208. In a corresponding manner, the third lens surface 214 may be smaller or larger than the further second lens surface 212, etc. In general, to implement the optical function it suffices that a lens element 204, 206 overlaps the clear aperture of the underlying lens element 202, 204 (along the direction of the optical axis 220). The second lens element 204 may thus fully cover the first lens element 202, or only partially cover the first lens element 202. In a corresponding manner the third lens element 206 may fully cover the second lens element 204, or only partially cover the second lens element 204, etc. In case of a “partial coverage”, the direct interface between the lens elements 202, 204, 206 may correspond to the smaller of the two lens surfaces 208, 210, 212, 214 forming the interface.

In other aspects, the direct interface between lens elements 202, 204, 206 may have a smaller lateral extension (e.g., a smaller diameter) compared to the lens surfaces 206, 208, 212, 214. Illustratively, the direct coupling between the lens elements 202, 204, 206 may be in a portion of the lens surfaces 208, 210, 212, 214 while a remaining portion of the lens surfaces 208, 210, 212, 214 may be uncoupled (not in direct contact with one another). This may be the case, for example, if there are portions of one of the lens surfaces 208, 210, 212, 214 with a profile that prevents the direct coupling. As another example, this may be the case if an aperture element is interposed between the lens elements 202, 204, 206 in correspondence of a portion of the lens surfaces 208, 210, 212, 214 as discussed in further detail below. The direct interface may in general be formed between at least a portion of the lens surfaces, e.g. between at least a portion of the first lens surface 208 and second lens surface 210, between at least a portion of the further second lens surface 212 and the third lens surface 214, etc. The at least one portion may be, for example, a central portion of the lens surfaces 208, 210, 212, 214, e.g. a region centered around the optical axis 220 of the optical component, e.g. a circular region, a square region, a rectangular region, an elliptical region, and the like. In another configuration, the at least one portion may be a lateral portion (illustratively a side portion) of the lens surfaces 208, 210, 212, 214.

As mentioned, in various aspects a lens element 204, 206 may be disposed to overlap the clear aperture of the underlying lens element 202, 204. In an exemplary configuration, the lens elements of the optical component 200 (e.g., the first lens element 202, the second lens element 204, the third lens element 206, etc.) may be coaxially aligned with one another. Illustratively, the lens elements 202, 204, 206 may be disposed (aligned) along the optical axis 220 of the optical component 200. The individual optical axes of the lens elements 202, 204, 206 may (fully) overlap with one another, illustratively the individual optical axes may be aligned with one another. Further illustratively, the lens elements 202, 204, 206 may be centered around the optical axis 220 of the optical component 200.

As another possibility, the individual optical axes of the lens elements 202, 204, 206 may not overlap with one another. This configuration may be rare in practical applications, but it may be provided for some particular optical functions to be implemented. In this configuration, the optical axes of the lens elements 202, 204, 206 may illustratively be shifted with respect to one another.

In principle, the optical component 200 and the lens elements 202, 204, 206 may have any suitable dimension, e.g. depending on the structure of an end device into which the optical component 200 should be integrated. In a preferred configuration for which the proposed strategy may be particularly relevant, the lens elements 202, 204, 206 may have dimensions in the micrometer range. As a numerical example, a lens element 202, 204, 206 may have a diameter in the range from 10 μm to 10 mm, for example in the range from 20 μm to 5 mm, for example in the range from 100 μm to 1 mm. As another numerical example, a lens element 202, 204, 206 may have a diameter in the range from 10 μm to 500 μm, for example in the range from 20 μm to 200 μm, for example in the range from 30 μm to 100 μm.

In a corresponding manner, a thickness of a lens element 202, 204, 206 may be in the micrometer range. A “thickness” may be a dimension of a lens element 202, 204, 206 along the direction of the respective optical axis, e.g. along the direction of the optical axis 220 of the optical component. As a numerical example, a lens element 202, 204, 206 may have a thickness in the range from 10 μm to 10 mm, for example in the range from 20 μm to 5 mm, for example in the range from 100 μm to 1 μm. It is however understood that the strategy proposed herein may apply in a corresponding manner to lens elements having other dimensions (e.g., larger dimensions).

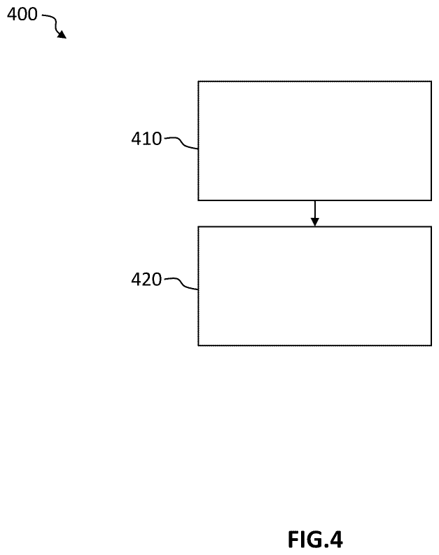

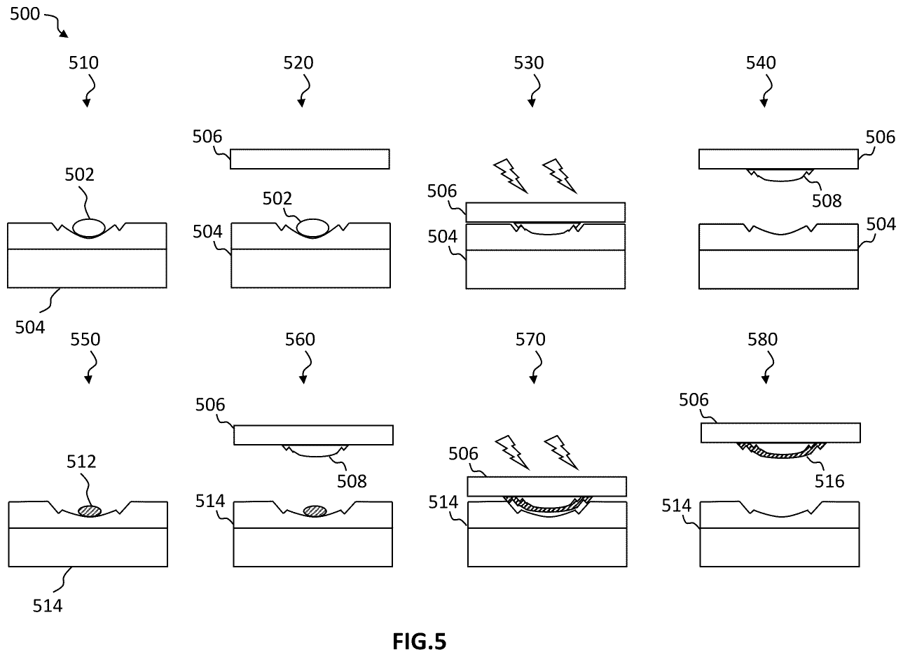

In general, the optical component 200 and the lens elements 202, 204, 206 may be fabricated using any suitable fabrication technique. In a preferred configuration, the lens elements 202, 204, 206 may be manufactured via a wafer-level process (see also FIG. 4 and FIG. 5). The term “wafer-level”, e.g. in relation to an optical component or a lens element may be used herein to indicate that the corresponding entity is fabricated/structured using wafer-level optics techniques, such as UV molding replication, lithography, etc. Various aspects related to wafer-level processing will be described in further detail in relation to FIG. 4 and FIG. 5. It is however understood that the optical component 200 and the lens elements 202, 204, 206 may alternatively be fabricated with processing techniques that do not belong to the wafer-level optics context, e.g. in case of greater dimensions of the optical component 200.

In this regard, a lens element 204, 206 may be formed on the underlying lens element 202, 204 in any suitable manner. According to various aspects, a lens element 204, 206 may be overmolded on the underlying lens element 202, 204, e.g. the second lens element 204 may be overmolded on the first lens surface 208 of the first lens element 202, the third lens element 206 may be overmolded on the further second lens surface 212 of the second lens element 204, etc. Overmolding has been found to enable a simple and reproducible fabrication of the optical component, e.g. in the context of wafer-level optics. For example, a lens element 202, 204, 206 may be formed via compression molding, injection molding, and the like.

In case a lens element 202, 204, 206 is fabricated via molding, the lens element 202, 204, 206 may include a lens portion and a yard portion. The yard portion may be the result of an overflow of the material of the lens element during fabrication (see also FIG. 5). In this configuration, the lens elements 202, 204, 206 may be coupled with one another at the respective lens portions. Illustratively, the lens portion may be the part of the lens element 202, 204, 206 implementing the optical function/lens function, and the interface between stacked lens elements 202, 204, 206 may be formed in correspondence of the respective lens portions.

In principle, the lens elements 202, 204, 206 of the optical component 200 may include or may be made of any suitable material. In general, a lens element 202, 204, 206 may include or may be made of a material that allows transmission of light in the predefined wavelength range in which the optical component 200 should operate (e.g., visible, near-infrared, etc.). As a numerical example, a lens element 202, 204, 206 may include or may be made of a material configured to have a transmission greater than 90% in the above mentioned wavelength ranges, for example a transmission greater than 94%.

In a preferred configuration, the lens elements 202, 204, 206 may include or may be made of an epoxy material. Epoxy may enable a scalable and reproducible fabrication of lens elements 202, 204, 206, e.g. in the context of wafer-level optics techniques, and may be a type of material capable of sustaining temperature treatments (e.g., reflow), while also providing suitable optical properties. Furthermore, in the context of wafer-level processing, epoxy materials may be precisely disposed and patterned using well-established techniques, thus allowing the introduction of the proposed configuration in existing process flows without the need for extensive adaptations of the equipment or of the workflow. As other suitable examples, a lens element 204 may include or may be made of glass, a thermal plastic material (acrylate or polycarbonate based), or an optical polymer material, e.g. an UV-curable polymer such as a thiol-ene based polymer, an acrylate resin, and the like.

According to various aspects, the optical properties of the lens elements 202, 204, 206 may be adapted to reduce or eliminate aberrations, e.g. spherical aberrations and/or chromatic aberrations. In this regard, materials having suitable refractive index and Abbe number may be selected for forming the lens elements 202, 204, 206 to reduce or eliminate the aberrations and, in general, to optimize the optical function of the optical component 200. In general, the material of each lens element 202, 204, 206 may have a respective refractive index and a respective Abbe number (e.g., a first refractive index and a first Abbe number for a first material of the first lens element 202, a second refractive index and a second Abbe number for a second material of the second lens element 204, a third refractive index and a third Abbe number for a third material of the third lens element 206, etc.).

The expression “refractive index” may be used herein to describe the absolute refractive index of a material, illustratively the ratio of the speed of light in vacuum to the speed of light in the material. Various methods exist to measure the refractive index of a material, such as via a refractometer (e.g., an Abbe refractometer). It is understood that references herein to a comparison between the refractive indexes of different materials refer to the respective refractive index at the same wavelength (e.g., the operating wavelength of the optical component 200).

The term “Abbe number” may be used to describe the degree of light dispersion in a transparent material, illustratively, the change of refractive index versus wavelength, as known in the art. The “Abbe number” may represent the dispersion ability of the material, e.g. the dispersion may be larger for smaller “Abbe numbers”, and the dispersion may be smaller for larger “Abbe numbers”. The “Abbe number” may also be referred to as “V number”.

References herein to the “refractive index of a lens element” or to the “Abbe number of a lens element” may be understood as references to the “refractive index of the material of the lens element”, and to the “Abbe number of material of the lens element”, and vice versa.

According to various aspects, the refractive index (and Abbe number) of at least two of the lens elements 202, 204, 206 of the optical component 200 may be different to allow a tailoring of the optical properties. For example, the first refractive index n₁, of the first lens element 202 may be different from the second refractive index n₂ of the second lens element 204. As another example, the third refractive index n₃ of the third lens element 206 may be different from the second refractive index n₂ of the second lens element 204. Additionally or alternatively, the third refractive index n₃ of the third lens element 206 may be different from the first refractive index n₁ of the first lens element 202, etc. As a further example, the third refractive index n₃ of the third lens element 206 may be different from the second refractive index n₂ of the second lens element 204 and may be equal to the first refractive index n₁ of the first lens element 202.

In a corresponding manner, the Abbe number V₁ of the first lens element 202 may be different from the second Abbe number V₂ of the second lens element 204. As another example, the third Abbe number V₃ of the third lens element 206 may be different from the second Abbe number V₂ of the second lens element 204. Additionally or alternatively, the third Abbe number V₃ of the third lens element 206 may be different from the first Abbe number V₁ of the first lens element 202, etc. As a further example, the third Abbe number V₃ of the third lens element 206 may be different from the second Abbe number V₂ of the second lens element 204 and may be equal to the first Abbe number V₁ of the first lens element 202.

Different optical properties for different lens elements 202, 204, 206 may be obtained, for example, using different materials for the different lens elements 202, 204, 206. For example, the first material of the first lens element 202 (e.g., a first epoxy material) may be different from the second material of the second lens element 204 (e.g., a second epoxy material). A third material of the third lens element 206 (e.g., a third epoxy material) may be different from the first material and/or the second material, etc. As another option, the lens elements 202, 204, 206 may include the same base material, and the different optical properties may be obtained by suitably doping the base material with different dopants and/or different concentration of dopants in different lens elements 202, 204, 206.

In principle, the properties of the lens elements 202, 204, 206 in terms of refractive index and Abbe number may be selected depending on the desired optical profile of the optical component 200. As an exemplary configuration, the first refractive index n₁ of the first lens element 202 may be greater than the second refractive index n₂ of the second lens element 204, and the first Abbe number V₁ may be less than the second Abbe number V₂. In this configuration, for example, the third refractive index n₃ of the third lens element 203 may be less than the second refractive index n₂, and the third Abbe number V₃ may be greater than the second Abbe number V₂.

As another exemplary configuration, the first refractive index n₁ of the first lens element 202 may be less than the second refractive index n₂ of the second lens element 204, and the first Abbe number V₁ may be greater than the second Abbe number V₂. In this configuration, for example, the third refractive index n₃ of the third lens element 203 may be greater than the second refractive index n₂, and the third Abbe number V₃ may be less than the second Abbe number V₂.

As exemplary values, the refractive index of a lens element may be at least 1% greater than the refractive index of another lens element, for example at least 2% greater, for example at least 5% greater, for example at least 10% greater. As other exemplary values, the Abbe number of a lens element may be at least 10% greater than the Abbe number of another lens element, for example at least 20% greater, for example at least 30% greater.

It is understood that in other aspects the refractive index (and Abbe number) of at least two of the lens elements 202, 204, 206 of the optical component 200 may be equal to one another. For example, the first refractive index n₁, of the first lens element 202 may be equal to the second refractive index n₂ of the second lens element 204. As another example, the third refractive index n₃ of the third lens element 206 may be equal to the second refractive index n₂ of the second lens element 204. Additionally or alternatively, the third refractive index n₃ of the third lens element 206 may be equal to the first refractive index n₁ of the first lens element 202, etc. In a corresponding manner, the Abbe number V₁ of the first lens element 202 may be equal to the second Abbe number V₂ of the second lens element 204. As another example, the third Abbe number V₃ of the third lens element 206 may be equal to the second Abbe number V₂ of the second lens element 204. Additionally or alternatively, the third Abbe number V₃ of the third lens element 206 may be equal to the first Abbe number V₁ of the first lens element 202, etc.

As an exemplary configuration, the lens elements may stacked to define alternating values for the refractive index and Abbe number. For example, the optical component 200 may include the first lens element 202 with first refractive index n₁ and first Abbe number V₁, the second lens element 204 with second refractive index n₂ and second Abbe number V₂, the third lens element 204 with (again) the first refractive index n₁ and first Abbe number V₁, a fourth lens element with the second refractive index n₂ and second Abbe number V₂, a fifth lens element with the first refractive index n₁ and first Abbe number V₁, etc.

According to various aspects, the optical component 200 may further include a substrate 216, e.g. an optical substrate, as shown for the exemplary configurations 200c, 200d in FIG. 2C and FIG. 2D. FIG. 2C shows an optical component 200c with a substrate 216 and two lens elements 202, 204, and FIG. 2D shows an optical component 200d with a substrate 216 and three lens elements 202, 204, 206. It is understood that the aspects discussed in relation to FIG. 2C and FIG. 2D may apply in a corresponding manner to a configuration with more than three lens elements.

The lens elements 202, 204, 206 may thus be disposed on the substrate 216. For example, the substrate 216 may provide mechanical support to the lens elements 202, 204, 206 for fabrication via wafer-level optics techniques. The substrate 216 may include or may be made of any suitable refractive material, such as a glass (e.g., borosilicate glass or alumina borosilicate glass), optical filter glass, an epoxy, a polymer, and the like. In some aspects, the substrate 216 may be a wafer, e.g., a glass wafer, an epoxy wafer. As other examples, the substrate 216 may include or may consist of an oxide, a nitride, an oxynitride, and the like.

In general the substrate 216 may be configured to allow transmission of light, e.g. in the predefined wavelength range in which the optical component 200 operates. Illustratively, the substrate 216 may be configured to allow light (with wavelength in the predefined range) to pass through. As an example, the predefined wavelength range may be the visible range, infrared and/or near-infrared range, or any other suitable range, as discussed above. As a numerical example, the substrate 216 may include or may be made of a material configured to have a transmission greater than 90% in the above mentioned wavelength ranges, for example a transmission greater than 94%. In some aspects, the substrate 216 may be configured to filter out light with wavelength outside the predefined wavelength range. For example, the material of the substrate 216 may be transmissive only in the desired wavelength range. As another example, the substrate 216 may have a coating configured to block light with wavelength outside the predefined wavelength range. In general, the dimensions of the optical substrate 216 may be adapted based on the desired use case, e.g. based on the overall dimensions of the optical component 200 or of the corresponding imaging device in which the optical component 200 is integrated.

According to various aspects, as shown in FIG. 2C and FIG. 2D, the first lens element 202 may be disposed (e.g., formed) on the substrate 216. Illustratively, considering the lens stack, the first lens element 202 may be disposed closest to the substrate compared to the other lens elements 204, 206. In some aspects, the lens element 202 disposed on the substrate 216 may have at least one planar surface (e.g., the first lens element 202 may be a plano-concave lens, or a plano-convex lens, as examples) to facilitate disposing/forming the lens element 202 on the substrate 216. As mentioned, the further lens elements 204, 206 may be formed using the underlying lens element 202, 204 as “substrate”.

According to various aspects, the optical component 200 may include additional elements (not shown in FIG. 2A to FIG. 2D), e.g. additional layers, to implement various optical functions.

As an example, the optical component 200 may include an aperture element configured to define an aperture (in other words, an opening) for the optical component 200 to, during an operation of the optical component 200, partially block light and partially allow light to pass through the aperture. The aperture element may include a material that is non-transmissive for the wavelength range in which the optical component 200 operates, and may include an area free of the non-transmissive material to define the opening. The opening may illustratively be a clear aperture through which light may propagate. The aperture element may contribute to the suppression of stray light, e.g. in the context of light detection. As exemplary materials, the aperture element may include a metal, such as chrome, e.g. black chrome.

In a simple configuration, the aperture element may be disposed on the substrate 216 of the optical component 200 (if present). This disposition of the aperture element allows for a simple fabrication. For example, the aperture element may be a layer disposed between the substrate 216 and the first lens element 202. As another example, the aperture element may be disposed at the side of the substrate 216 facing away from the lens elements 202, 204, 206.

In a more complex configuration, the aperture element may be disposed between two of the lens elements 202, 204, 206 of the lens stack. For example, the aperture element may be a layer disposed between the first lens surface 208 of the first lens element 202 and the second lens surface 210 of the second lens element 204. As another example, the aperture element (or a further aperture element) may be a layer disposed between the further second lens surface 212 of the second lens element 204 and the third lens surface 214 of the third lens element 206, etc. In this configuration, the direct interface between the lens surfaces 208, 210, 212, 214 may be an interface through the aperture defined by the aperture element. This configuration may be provided in absence of the substrate 216, or even in a configuration with the substrate 216 to flexibly adapt the position of the aperture element within the layer stack.

As another exemplary configuration, additionally or alternatively, the optical component 200 may include a spectral filter. The spectral filter may be configured to filter light, e.g. to block light with wavelength outside a predefined wavelength range. The spectral filter may thus enhance the signal to noise ratio of imaging carried out using the optical component 200. The spectral filter may be configured to block light with wavelength outside any suitable wavelength range according to the desired application of the optical component 200 (and corresponding imaging device). As an example, the spectral filter may block light with wavelength outside of the visible range. As another example, the spectral filter may block light with wavelength outside of the near-infrared range. In a preferred configuration, the spectral filter may block light with wavelength outside of (only) part of the near-infrared range, illustratively a limited bandwidth within the near-infrared range. In this regard, the spectral width of the predefined wavelength range may be adapted according to a desired balance between the selectivity of the filter and the necessity to allow sufficient light to reach the image sensor. As a numerical example, the spectral filter may block light with wavelength outside of a wavelength range with spectral width of about 1000 nm, for example 500 nm, for example 300 nm. As further numerical examples, the spectral filter may block light with wavelength outside of a wavelength range with a spectral width in the range from 5 nm to 200 nm, for example a spectral width in the range from 10 nm to 100 nm, for example a spectral width in the range from 20 nm to 50 nm. In a corresponding manner, as an alternative configuration, the spectral filter may be configured to allow to pass light with wavelength in a predefined wavelength range, e.g. the spectral filter may be configured as a bandpass filter (e.g., a near infrared bandpass filter).

The spectral filter may be disposed at any suitable location within the optical component 200. For example, the spectral filter may be disposed on the substrate 216 of the optical component 200 (if present). This disposition of the spectral filter allows for a simple fabrication. For example, the spectral filter may be a layer disposed between the substrate 216 and the first lens element 202. As another example, the spectral filter may be disposed at the side of the substrate 216 facing away from the lens elements 202, 204, 206.

As a further exemplary configuration, additionally or alternatively, the optical component 200 may include one or more anti-reflective features, e.g. anti-reflective nanostructures. For example, at least one of the lens elements 202, 204, 206 may have a structured surface that provides anti reflective properties. In a preferred configuration, the outermost lens element (e.g., the second lens element 204 in FIG. 2A, the third lens element 206 in FIG. 2B) may include the structured surface with anti-reflective properties. Illustratively, the outermost lens surface of the lens stack (e.g., the further lens surface 212 of the second lens element 204 in FIG. 2A, a further (third) lens surface 218 of the third lens element 206 in FIG. 2B) may include an anti-reflective feature, e.g. an anti-reflective feature made of nanostructures. The anti-reflective structures may thus be disposed at the interface with the medium in which the optical component 200 operates (e.g., air in a common scenario). It is however understood that, in principle, more than one lens element 202, 204, 206 e.g. each lens element 202, 204, 206, or a lens element 202, 204, 206 other than the outermost lens element may include a lens surface with an anti-reflective feature.

A nanostructured surface may be configured in any suitable manner to provide anti-reflective properties. In general, a nanostructured surface may include an array of nanostructures, e.g. nano-pillars, nano-pyramids, stochastic cloudlets, sponge-like nanostructures, and/or the like. The array of nanostructures forming the nanostructured surface may have a sub-wavelength pitch, illustratively a sub-wavelength center to center distance between neighboring nanostructures. The design of the nanostructured surface may thus be adapted according to the intended application of the optical component 200, e.g. for imaging in the visible range, or near-infrared range, as examples. The pitch may be smaller than the shortest wavelength in the predefined wavelength range associated with the operation of the compound lens.

It is understood that the aspects discussed in relation to the single optical component 200 in FIG. 2A to FIG. 2D may be extended in a corresponding manner to an array of optical components 200. In some aspects, an array of optical components 200 may be provided, in which each optical component 200 has a lens stack in which the lens elements are formed directly on one another, as discussed above. An array of optical components 200 may be provided, for example, to implement an optical function for an array of pixels, e.g. an array of photo detectors. As another example, an array of optical components 200 may be provided to implement an optical function for an array of light emitters, e.g. a VCSEL array. The possibility of forming the optical component 200 using wafer-level optics techniques enables the parallel fabrication of a plurality of optical components (e.g., on the same substrate, e.g. the same wafer), so that an array of optical components 200 may be provided in a scalable and reproducible manner.

In principle, the configuration proposed herein may be applied for any suitable type of lens element. In general, the shape and sequence of lens elements within the lens stack may be selected to implement a suitable optical function, e.g. converging light, diverging light, collimating light, and the like. In this regard, FIG. 3A shows possible lens types for the lens elements 202, 204, 206 of the optical component 200. As possible lens types, a lens element of the optical component may be configured as a plano-convex lens 302, as a plano-concave lens 304, as a positive meniscus lens 306 (a convex-concave lens thicker at the center than at the edges), as a negative meniscus lens 308 (a convex-concave lens thicker at the edges than at the center), as a biconvex lens 310, or as a biconcave lens 312. It is understood that also other lens types may be provided.

In general, if the optical component 200 includes a substrate 216, the lens element disposed on the substrate 216 (e.g., the first lens element 202) may have at least one planar surface, illustratively a flat surface, as mentioned above. The planar surface may be in contact with the substrate 216, while the other surface of the (first) lens element may be a curved surface, e.g. with a convex shape or a concave shape.

In general, each lens element 202, 204, 206 may be a corresponding lens type, e.g. the first lens element 202 may be of a first lens type, the second lens element 204 may be of a second lens type, the third lens element 206 may be of a third lens type, etc. The lens types may be selected according to the optical function to be implemented. For example, at least two lens elements may be of the same lens type, e.g. the first lens type may be the same as the second lens type (and/or as the third lens type). As another example, at least two lens elements may be of different lens type, e.g. the first lens type may be different from the second lens type (and/or from the third lens type).

In a preferred configuration, the lens elements 202, 204, 206 may be disposed to have respective curved surfaces that allow disposing the lens elements on one another. Illustratively, the lens surface 210, 214 of a lens element 204, 206 may have a profile that conforms to the profile of the lens surface 208, 212 of the underlying lens element 202, 204. For example, the profile of the second lens surface 210 may conform to the profile of the first lens surface 208, the profile of the third lens surface 214 may conform to the profile of the further second lens surface 212, etc. In some aspects, the lens surface 210, 214 of a lens element 204, 206 may have a profile that is complementary to a profile of the lens surface 208, 212 of the underlying lens element 202, 204 (e.g., a convex surface may be formed on a concave surface, as an example). For example, the profile of the second lens surface 210 may be complementary to the profile of the first lens surface 208, the profile of the third lens surface 214 may be complementary to the profile of the further second lens surface 212, etc. For example, the second lens element 204 may have a biconvex shape, biconcave shape, or meniscus shape (either negative or positive). In some aspects, the second lens element 204 may have itself a plano-concave or plano-convex shape, with the curved surface facing the curved surface of the first lens element 202, and with the planar surface facing away from the first lens element 202. These configurations may apply in a corresponding manner to the third lens element 206 and further lens elements (if present).

In this regard, FIG. 3B shows exemplary configurations of an optical component 300a, 300b. As shown, the optical component 300a, 300b may include a substrate 314 (e.g., configured as the substrate 216), and two lens elements 316, 318 (e.g., exemplary realizations of the first lens element 202 and second lens element 204). The first lens element 316 may have a plano-concave shape, as an example, and the second lens element 318 may have a curved surface conforming to the concave surface of the first lens element 316. For example, in the configuration 300 a, the second lens element 318 may have a positive meniscus shape. As another example, in the configuration 300b, the second lens element 318 may have a biconvex shape.

FIG. 3C and FIG. 3D show microscope pictures 320c, 320d of an optical component configured as described herein. As visible in the microscope pictures 320c, 320d, the optical component may include lens elements formed directly on one another, without bonding layers therebetween, so that the lens elements may be fixedly coupled in a robust manner that also reduces or prevents the risk of misalignments. For example, the optical component in FIG. 3C may include a plano-convex lens element disposed on a substrate (e.g., a glass wafer), and a positive meniscus lens element disposed on the convex surface of the plano-convex lens element. As another example, the optical component in FIG. 3C may include a plano-concave lens element disposed on a substrate (e.g., a glass wafer), and a negative meniscus lens element disposed on the concave surface of the plano-concave lens element. The optical components in FIG. 3C and FIG. 3D may be obtained with wafer-level optics techniques, and a yard portion may be visible (in particular in FIG. 3C), which may result from the overflow of material during fabrication (e.g., during molding).

FIG. 4 shows a schematic flow diagram of a method 400 of fabricating an optical component. The method 400 may be related to the fabrication of the optical component 200 described in relation to FIG. 2A to FIG. 3D. It is understood that the aspects described in connection with the optical component 200 may apply in a corresponding manner to the method 400, and vice versa. In general, the forming of the various parts of the optical component may be carried out with conventional techniques. In a preferred configuration, the forming of the various parts of the optical component may be carried out via wafer-level fabrication techniques (see also FIG. 5).

In general, the method 400 may include forming a plurality of lens elements directly on one another, e.g. the method may include forming a lens element using another lens element as a substrate. Illustratively, the method 400 may include forming (e.g., overmolding) a lens element directly on the lens surface of another (underlying) lens element to fixedly couple the lens elements via a direct interface between the respective lens surfaces.

In various aspects, the method 400 may include, in 410, providing a first lens element (configured as a lens of a first lens type, to perform a first lens function), and, in 420, forming a further second lens element (configured as a lens of a second lens type, to perform a second lens function) directly on a first lens surface of the first lens element, such that the further second lens element is fixedly coupled with the first lens element via a direct interface between the first lens surface of the first lens element and a further second lens surface of the further second lens element. In some aspects, the method 400 may further include forming a third lens element (configured as a lens of a third lens type, to perform a third lens function) directly on a further lens surface of the second lens element to fixedly couple the third lens element and the second lens element via a direct interface between the further lens surface and a third lens surface of the third lens element. The method 400 may be further extended to providing a fourth lens element, a fifth lens element, etc.

In principle, a lens element may be provided (e.g., fabricated) with any suitable technique and with any suitable material (e.g., an epoxy in a preferred configuration, or other suitable materials such as glass, an optical polymer, etc.). For example, considering wafer-level optics, a lens element may be fabricated via a master stamp designed according to the configuration (e.g., shape, size, etc.) of the lens element to be fabricated. The master stamp may allow transferring the desired pattern into a curable material, such as an epoxy material, which may then be cured (e.g., via irradiation, for example with ultraviolet (UV) light). A suitable approach for wafer-level optics may include a so called “step-and-repeat ultraviolet imprint lithography”, in which individual molds for the lens elements are replicated on a substrate (e.g., a wafer) using high precision alignment. The stamp (e.g., the master stamp, or a corresponding working stamp) may define the shape of a curable material disposed on the substrate, and the subsequent irradiation (e.g., via UV light) may cure the material in the desired shape. Typical deposition methods may include puddle dispense or ink jet dispense.

Thus, in an exemplary configuration, providing a lens element may include disposing a material of the lens element in a replication tool. The replication tool may be shaped according to a target profile for the lens element. For example, the replication tool may have a replication site (or a plurality of replication sites for parallel fabrication) defining a curved surface, e.g. a convex surface or a concave surface, or any other suitable profile. The material of the lens element may be for example an epoxy material as discussed in relation to FIG. 2A to FIG. 3D. Providing a lens element may further include curing the material of the lens element, for example via UV irradiation. In some aspects, providing a lens element may include contacting the replication tool with an optical substrate (e.g., a wafer, such as a glass wafer), and curing the material to form the lens element on the substrate.

After curing, further processing steps may be carried out to finalize the optical component. Such further processing steps may be carried out at the wafer-level, thus providing an efficient and streamlined procedure for the completion of the fabrication. The further processing steps may include, for example, de-molding, cleaning, polishing, edge removal, coating, and stacking. Wafer-level optics may include stacking the wafers including the individual optical components, e.g. via wafer bonding, to provide an optical module having the desired number and arrangement of optical elements. Wafer-level optics may further include dicing the wafer stack to provide individual optical modules, e.g. to be placed and coupled with an image sensor.

According to various aspects, providing a lens element may include a molding process. For example, providing the first lens element 410 may include a disposing a first material (e.g., a first epoxy material) in a first replication site of a first replication tool. The first replication site may correspond to a negative of a shape of the first lens element (e.g., for a convex lens element the replication site may have a concave shape, for a concave lens element the replication site may have a convex shape, etc.). Providing the first lens element 410 may further include bringing the first material in contact with a substrate (e.g., an optical substrate, e.g. a glass wafer), such that the first material distributes on the optical substrate according to the shape of the first replication site. Illustratively, providing the first lens element 410 may include approaching the first replication tool to the substrate to allow the first material to spread and fill the first replication site. Providing the first lens element 410 may further include causing a hardening of the first material to form the first lens element. For example, providing the first lens element 410 may include curing the first material (e.g., via UV irradiation, or via heating), to form the first lens element on the substrate.

According to various aspects, forming a lens element on another lens element may include overmolding the lens element on the (underlying) other lens element. Overmolding may provide a scalable, efficient, and relatively simple fabrication process to provide the proposed configuration. Forming a lens element on another lens element may thus include disposing a further material in a further replication site of a further replication tool and bringing the further material in contact with the lens surface of the (underlying) lens element to allow the further material to distribute according to the shape of the further replication site. The method may further include causing a hardening of the further material to form the further lens element on the underlying lens element.

For example, considering a second lens element formed on the first lens element, forming the second lens element 420 may include overmolding the second lens element directly on the first lens surface of the first lens element. Forming the second lens element 420 may thus include disposing a second material (e.g., a second epoxy material, for example different from the first epoxy material) in a second replication site of a second replication tool. The second replication site may correspond to a negative of a shape of the second lens element. Forming the second lens element 420 may further include bringing the second material in contact with a first lens surface of the first lens element, such that the second material distributes on the first lens surface according to the shape of the second replication site. Illustratively, forming the second lens element 420 may include approaching the second replication tool to the first lens element to allow the second material to spread and fill the second replication site. Forming the second lens element 420 may further include causing a hardening of the second material to form the second lens element. For example, forming the second lens element may include curing the second material (e.g., via UV irradiation, or via heating), to form the second lens element on the first lens element.

The overmolding may be repeated to form a third lens element on the second lens element, a fourth lens element on the third lens element, etc.

In general, considering a molding process, the method 400 may include aligning the replication tools to the positions where the lens elements should be formed. For example, the method 400 may include aligning the first replication tool to a predefined position on the substrate prior to bringing the first material in contact with the substrate. As another example, the method 400 may include aligning the second replication tool with the location of the first lens element prior to bringing the second material in contact with a first lens surface, etc.

FIG. 5 shows a method 500 of fabricating an optical component as described herein, in an illustrative representation according to various aspects. The method 500 may be an exemplary realization of the method 400 described in FIG. 4. It is understood that the method 500 illustrates processing steps that have been found suitable to obtain the configuration proposed herein, but also other types of processing steps may be provided.

The method 500 may include, in 510, disposing a first material 502 to form a first lens element on a first replication tool 504 (also referred to as lens tool). The first material 502 of the first lens element may be for example a first epoxy material. In the exemplary configuration in FIG. 5, the replication tool 504 may be structured to define a concave profile for the first lens element. For example, the first material 502 may be disposed on the replication tool 504 via epoxy jetting.

The method 500 may further include, in 520, bringing the first replication tool 504 in contact with an optical substrate 506 (e.g., a glass wafer) to define the first lens element on the surface of the substrate 506. As shown, the replication site in the replication tool 504 may also include a yard portion to allow an overflow of first material 502 during the formation of the first lens element. With the first replication tool 504 in contact with the substrate 506 the method 500 may include, in 530, curing the first material 502, e.g. via UV-curing, illustratively via irradiation with UV light (or any other suitable curing process depending on the first material of the first lens element). After curing, the method 500 may include, in 540, separating the substrate 506 from the first replication tool 504 (e.g., a wafer separation), leaving the first lens element 508 on the substrate.

After having formed the first lens element 508 in the first part of the method 500, the second part of the method 500 may be related to forming a second lens element 516 directly on the surface of the first lens element 508. In this regard, the method 500 may include, in 550, disposing a second material 512 to form the second lens element on a second replication tool 504 (also referred to as lens tool). For example, the second material 512 may be a second epoxy material (e.g., different from the first epoxy material).

The method 500 may further include, in 560, bringing the second replication tool 514 in contact with the substrate 506 in which the first lens element 508 was formed (e.g., after an alignment process, for example using alignment marks). As shown, the second material 512 may distribute on the lens surface of the first lens element 508 to form the second lens element 516 directly on the lens surface, thus providing a fixed coupling without further intervening bonding layers. As shown, the replication site in the second replication tool 514 may also include a yard portion to allow an overflow of second material 512 during the formation of the second lens element 516. With the second replication tool 514 in contact with the substrate 506 the method 500 may include, in 570, curing the second material 512, e.g. via UV-curing or any other suitable curing treatment. After curing, the method 500 may include, in 580, separating the substrate 506 from the second replication tool 514 (e.g., a wafer separation), leaving the second lens element 516 formed on the first lens element 508.

The method steps may be repeated to form further lens elements, e.g. a third lens element using a third material and a third replication tool, a fourth lens element using a fourth material and a fourth replication tool, etc. It is understood that the aspects discussed in relation to the fabrication of a single optical component may apply in a corresponding manner to the simultaneous fabrication of optical components, e.g. on a wafer.

Overall, the present disclosure provides a new approach to lens production (e.g., WLO lens production) that offers improved optical performance, design flexibility, and cost-effectiveness. The manufacturing process is highly scalable and can be easily adapted for high volume production of high-quality lenses (e.g., WLO lenses) for a variety of applications, such as AR/VR, micro camera lenses, etc.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [. . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

### LIST OF REFERENCE SIGNS

100 Imaging device
102 Image sensor
104 Optical module
106 Processor
108 Optical component
108b Optical element
110 Field of view
200 Optical component
200a Optical component
200b Optical component
200c Optical component
200d Optical component
202 First lens element
204 Second lens element
206 Third lens element
208 First lens surface
210 Second lens surface
212 Further second lens surface
214 Third lens surface
216 Substrate
218 Further third lens surface
220 Optical axis
230a View
230b View
300a Optical component
300b Optical component
302 Plano-convex lens
304 Plano-concave lens
306 Positive meniscus lens
308 Negative meniscus lens
310 Biconvex lens
312 Biconcave lens
314 Substrate
316 First lens element
318 Second lens element
320c Microscope picture
320d Microscope picture
400 Method
410 Method step
420 Method step
500 Method
502 First lens material
504 First replication tool
506 Substrate
508 First lens element
510 Method step
512 Second lens material
514 Second replication tool
516 Second lens element
520 Method step
530 Method step
540 Method step
550 Method step
560 Method step
570 Method step
580 Method step

1. An optical component comprising:
a first lens element configured as a lens of a first lens type; and
a second lens element configured as a lens of a second lens type,
wherein the second lens element is formed on a first lens surface of the first lens element, such that the second lens element is fixedly coupled with the first lens element via a direct interface between the first lens surface of the first lens element and a second lens surface of the second lens element.

2. The optical component according to claim 1,
wherein the first lens element comprises or is made of a first material,
wherein the second lens element comprises or is made of a second material, and
wherein the first material is different from the second material.

3. The optical component according to claim 2,
wherein the first material has a first refractive index and a first Abbe number,
wherein the second material has a second refractive index and a second Abbe number, and
wherein the first refractive index is different from the second refractive index, and the first Abbe number is different from the second Abbe number.

4. The optical component according to claim 2,
wherein the first material is or comprises a first epoxy material,
wherein the second material is or comprises a second epoxy material, and
wherein the first epoxy material is different from the second epoxy material.

5. The optical component according to claim 1,
wherein the first lens type is different from the second lens type.

6. The optical component according to claim 1,
wherein the direct interface between the first lens surface of the first lens element and the second lens surface of the second lens element comprises a direct physical contact between the first lens surface and the second lens surface.

7. The optical component according to claim 1,
wherein the second lens element is overmolded on the first lens surface of the first lens element.

8. The optical component according to claim 1, further comprising:
a substrate,
wherein the first lens element is disposed on the substrate.

9. The optical component according to claim 1, further comprising:
a third lens element configured as a lens of a third lens type,
wherein the third lens element is formed on a further lens surface of the second lens element, such that the third lens element is fixedly coupled with the second lens element via a direct interface between the further lens surface of the second lens element and a third lens surface of the third lens element.

10. The optical component according to claim 1,
wherein the first lens surface of the first lens element is a first curved surface, and
wherein the second lens surface of the second lens element is a second curved surface.

11. The optical component according to claim 10,
wherein a profile of the first curved surface of the first lens element is complementary to a profile of the second curved surface of the second lens element.

12. A method of fabricating an optical component, the method comprising:
providing a first lens element configured as a lens of a first lens type; and
forming a second lens element directly on a first lens surface of the first lens element, such that the second lens element is fixedly coupled with the first lens element via a direct interface between the first lens surface of the first lens element and a second lens surface of the second lens element,
wherein the second lens element is configured as a lens of a second lens type.

13. The method according to claim 12,
wherein forming the second lens element comprises overmolding the second lens element directly on the first lens surface of the first lens element.

14. The method according to claim 12,
wherein providing the first lens element comprises:
disposing a first material in a first replication site of a first replication tool,
wherein the first replication site corresponds to a negative of a shape of the first lens element;
bringing the first material in contact with an optical substrate, such that the first material distributes on the optical substrate according to the shape of the first replication site; and
curing the first material to form the first lens element on the optical substrate.

15. The method according to claim 14,
wherein forming the second lens element comprises:
disposing a second material in a second replication site of a second replication tool,
wherein the second replication site corresponds to a negative of a shape of the second lens element;
bringing the second material in contact with a first lens surface of the first lens element, such that the second material distributes on the first lens surface according to the shape of the second replication site; and
curing the second material to form the second lens element on the first lens surface of the first lens element.
